(19) United States
(12) Patent Application Publication
(10) Pub. No.: US 2020/0286188 A1
(43) Pub. Date: Sep. 10, 2020

(54) POWER DISTRIBUTION PRICING METHOD OF COMMERCIAL HVAC SYSTEM AND APPARATUS AND METHOD FOR LOAD SCHEDULING OF HVAC SYSTEM USING SAID PRICING METHOD

(71) Applicant: SEOKYOUNG SYSTEMS, Seoul (KR)

(72) Inventors: YoungSeok SOHN, Seongnam-si (KR); Youngjin KIM, Pohang-si (KR); Ye Eun JANG, Sejong-si (KR); Ahyun Yoon, SEOUL (KR)

(21) Appl. No.: 16/293,658

(22) Filed: Mar. 6, 2019

(51) Int. Cl. G06Q 50/06; G06Q 10/06; G06Q 30/02; G06N 5/02

(52) U.S. Cl. CPC G06Q 50/06; G06Q 10/067; G05B 2219/2614; G06Q 30/0206; G06N 5/02; G06Q 10/06314

(57) ABSTRACT

Provided is a power distribution pricing method of the commercial HVAC system and an apparatus and method for load scheduling of the HVAC system utilizing the same. The power distribution pricing method of the commercial HVAC system and the apparatus and method for load scheduling of the HVAC system utilizing the same can provide scheduling of the load according to the price of the input power which set on the previous day, to thereby provide a power distribution pricing method of the commercial HVAC system with high accuracy, high efficiency and high reliability, and an apparatus and method for load scheduling of the HVAC system using the method.

### BACKGROUND OF THE INVENTION

### Field of the Invention

The present invention relates to a power distribution pricing method of a commercial HVAC system and an apparatus and method for load scheduling of the HVAC system using the same, and more particularly, to a power distribution pricing method of a commercial HVAC system for inducing a demand response, and an apparatus and method for load scheduling of the HVAC system using the same.

### Related Art

A commercial HVAC system is a heat-treatment system that dynamically controls the temperature, ventilation, humidity, etc. in the building to keep them in an appropriate state, and uses input power provided by a distribution supplier as a power source.

In the centralized operation scheme of power distribution companies, storing power is difficult or expensive. In order to secure the stability and safety of electric power supply, a demand response, in which supply and demand are matched, is required.

However, conventional commercial HVAC systems are being controlled to keep the room temperature in a subject space constant at a certain value temperature, regardless of the retail price of the input power. As a result, power distribution companies are demanding to pay irrational fees to users of commercial HVAC systems by establishing a time-of-use (TOU) method with a relatively high distribution fee to maximize profits.

Such a conventional power distribution pricing method of commercial HVAC systems does not take into consideration the operation conditions of the distribution network and the power loss, so a reasonable new power distribution pricing method capable of applying the demand response is required.

### SUMMARY OF THE INVENTION

The present invention provides a power distribution pricing method of a commercial HVAC system of high efficiency and high reliability.

The present invention also provides an apparatus for load scheduling of an HVAC system of high efficiency and high reliability.

The present invention also provides a method for load scheduling of an HVAC system of high efficiency and high reliability.

In an aspect, an apparatus for scheduling a load is provided. The apparatus includes a memory, and a processor configured to execute at least one command within the memory, in which the processor schedules a load of a commercial HVAC (heating, ventilation, air conditioning) system, based on a power distribution pricing model associated with operating efficiency of the HVAC system according to a retail price of input power.

The power distribution pricing model may be derived by using a decision model.

The decision model may include an upper level decision model for calculating the retail price of the input power which guarantees a profit of a power distribution company.

The upper level decision model may calculate the profit of the power distribution company by deducting a wholesale price of the input power and an incremental power loss in a power distribution network from the retail price of the input power in a specific bus in the power distribution network which supplies the input power.

The retail price of the input power may be an amount of money between the wholesale price of the input power and a retail price of the input power which is calculated by a time-of-use (TOU) scheme for each time zone.

The decision model may include a lower level decision model for calculating an optimal operating cost for partial input power for each user of the at least one commercial HVAC system in a specific bus within a power distribution network which supplies the input power.

The lower level decision model may reflect a partial linear approximated section of the input power corresponding to a specific room temperature in a thermal reaction model, to thereby calculate an operating cost according to the input power within the approximated section.

The thermal reaction model may be modeled by measuring a change in a room temperature as a surrounding environment and time change in a specific space.

The surrounding environment may include at least one of variables including a surrounding temperature, an air temperature, an indoor convection current heat gain, an indoor radiant heat gain, and a cooling rate of the commercial HVAC system.

The scheduling may be performed is performed for a load within the HVAC system to be used a next day.

The power distribution pricing model may be based on a real-time pricing scheme.

In another aspect, a method for scheduling a load is provided. The method includes calculating a retail price according to input power, based on a power distribution pricing model, and scheduling at least one load within a commercial HVAC (heating, ventilation, air conditioning) system to be used a next day, according to the calculated retail price.

The method may further include generating the power distribution pricing model before calculating the retail price according to the input power based on the power distribution pricing model.

The generating of the power distribution pricing model may include calculating the retail price of the input power which guarantees a profit of a power distribution company by using an upper level decision model, and calculating an optimal operating cost for partial input power for each user of the at least one commercial HVAC system in a specific bus within a power distribution network which supplies the input power by using a lower level decision model.

The upper level decision model may calculate the profit of the power distribution company by deducting a wholesale price of the input power and an incremental power loss in a power distribution network from the retail price of the input power in a specific bus in the power distribution network which supplies the input power.

The retail price of the input power may be an amount of money between the wholesale price of the input power and a retail price of the input power which is calculated by a time-of-use (TOU) scheme for each time zone.

The generating of the power distribution pricing model by using the decision model may include generating a thermal reaction model before calculating the retail price of the input power which guarantees the profit of the power distribution company by using the upper level decision model.

The thermal reaction model may be modeled by measuring a change in a room temperature as a surrounding environment and time change in a specific space.

The power distribution pricing model may be based on a real-time pricing scheme.

In further another aspect, a power distribution pricing method for an input power distributed to a commercial HVAC (heating, ventilation, air conditioning) system is provided. The power distribution pricing method includes calculating a retail price of the input power in a specific bus within a power distribution network, calculating a partial input power use amount for the retail price of at least one user of the commercial HVAC system, and calculating the retail price of the input power by reflecting the partial input power use amount.

### BRIEF DESCRIPTION OF THE DRAWINGS

FIG. 1 is a block diagram of an apparatus for load scheduling of a commercial HVAC system according to an embodiment of the present invention.

FIG. 2 is a flowchart of a method for load scheduling of a commercial HVAC system according to an embodiment of the present invention.

FIG. 3 is a flowchart of a step of generating pricing model in a method for load scheduling of a commercial HVAC system according to an embodiment of the present invention.

FIG. 4 is an image of a test experimental model for generating a thermal reaction model according to an experimental example of the present invention.

FIG. 5 is a graph of a room temperature change according to an increase in input power of a commercial HVAC system according to an embodiment of the present invention.

FIG. 6 is a conceptual diagram for explaining a profit calculation of a commercial HVAC system according to an embodiment of the present invention.

### DESCRIPTION OF EXEMPLARY EMBODIMENTS

The present invention may be modified in various ways and have various embodiments, and some specific embodiments will be illustrated in the drawings and explained in the detailed description of the invention. It should be understood, however, that the present invention is not intended to be limited to particular embodiments, but includes all modifications, equivalents, and alternatives falling within the spirit and scope of the invention. Like reference numerals are used for like elements in describing each drawing.

The terms first, second, A, B, etc. may be used to describe various components, but the components should not be limited by the terms. The terms are used only for the purpose of distinguishing one component from another. For example, without departing from the scope of the present invention, the first component may be referred to as a second component, and similarly, the second component may also be referred to as a first component. The term “and/or” includes any combination of a plurality of related listed items or any of a plurality of related listed items.

It is to be understood that when an element is referred to as being “linked” or “connected” to another element, it may be directly linked or connected to the another element, or there may be another element therebetween. On the other hand, when an element is referred to as being “directly linked” or “directly connected” to another element, it should be understood that there are no other elements therebetween.

The terms used in the present application are only to describe a specific embodiment and is not intended to limit the invention. Singular expressions include plural expressions unless the context clearly dictates otherwise. In the present application, the terms “include” or “have” and the like are used to specify that a feature, a number, a step, an operation, an element, a part or a combination thereof described in the specification exist, and should be understood as not excluding the possibility of the presence or addition of one or more other features, integers, steps, operations, elements, parts, or combinations thereof in advance.

Unless defined otherwise, all terms used herein, including technical or scientific terms, have the same meaning as commonly understood by one of ordinary skill in the art to which this invention belongs. Terms such as those defined in commonly used dictionaries are to be interpreted as having a meaning consistent with the contextual meaning of the related art and are not to be interpreted as either ideal or overly formal unless clearly defined in the present application.

Hereinafter, preferred embodiments of the present invention will be described in detail with reference to the accompanying drawings. In order to facilitate the understanding of the present invention, the same reference numerals are used for the same constituent elements in the drawings and redundant explanations for the same constituent elements are omitted.

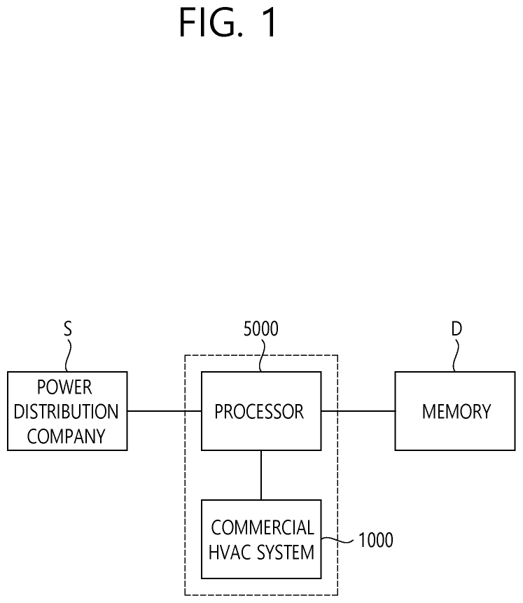

FIG. 1 is a block diagram of an apparatus for load scheduling of a commercial HVAC system according to an embodiment of the present invention.

Referring to FIG. 1, a load scheduling apparatus can schedule a load of the HVAC (Heating, Ventilation, Air Conditioning) system D in conjunction with a HAVC system provided in a commercial building. However, the load scheduling apparatus is not limited to the above, and can be installed in the HVAC system D and provided.

According to an embodiment, the load scheduling apparatus may schedule a load in the HVAC system D according to the retail price of input power distributed to the HVAC system D.

Here, the retail price of the power provided by a power distribution company S may be calculated using a bi-level decision model.

The bi-level decision model may be a model that is generated to reflect all of the positions of power distribution companies and users of commercial HVAC systems D with conflicting interests in the power distribution pricing.

According to an embodiment, the bi-level decision model is a model generated based on the Stackelberg game theory, and may include a high level decision step for reflecting the purpose of a power distribution company desiring to maximize the profit from power distribution retail and a lower level decision step for reflecting the purpose of a user using a commercial HVAC system D to maximize power efficiency but minimize the fee. A power distribution pricing method of a commercial HVAC system (D) using a bi-level decision model will be described in more detail in the description of the following load scheduling method.

According to an embodiment, the load scheduling apparatus may include a memory 1000 and a processor 5000.

The memory 1000 may include at least one command for executing the processor 5000 to be described later.

According to the embodiment, the at least one command may include a command to calculate a retail price of input power distributed to a commercial HVAC system using a power distribution pricing model, and a command to schedule the load in the commercial HVAC system to minimize the distribution charge according to the calculated retail price of the input power.

The processor 5000 may operate according to at least one command stored in the memory 1000, as described above. The operation of the processor 5000 will be described in more detail in the following description of the load scheduling method as described above.

The load scheduling apparatus of the commercial HVAC system according to the embodiment of the present invention has been described above. Hereinafter, the load scheduling method performed by the operation of the processor in the load scheduling apparatus will be described in more detail.

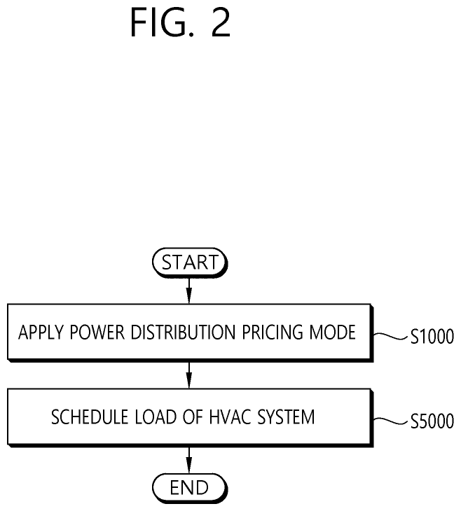

FIG. 2 is a flowchart of a method for load scheduling of a commercial HVAC system according to an embodiment of the present invention.

Referring to FIG. 2, the processor 5000 in the load scheduling apparatus may calculate a retail price of input power distributed to a commercial HVAC system using a power distribution pricing model (S1000). According to the embodiment, the power distribution pricing model is a real-time pricing (RTP) method in which the price of input power fluctuates in real time according to the size of a load applied to a specific bus in a distribution network.

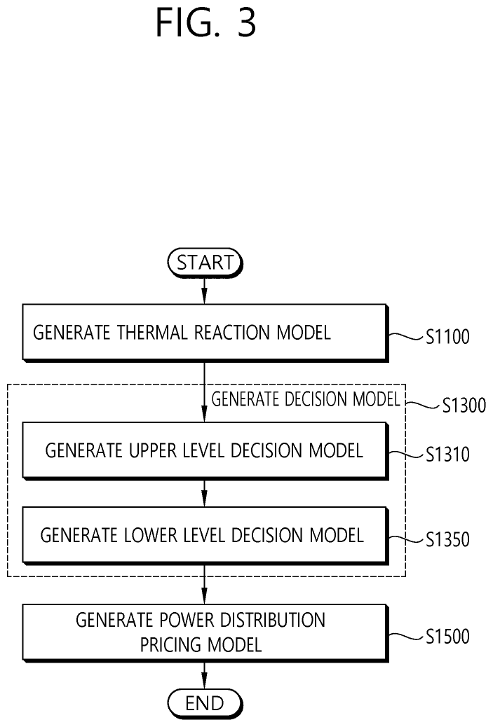

Here, the power distribution pricing model can be generated and provided before calculating the retail price of the input power. A method of generating a power distribution pricing model will be described in more detail with reference to FIG. 3.

FIG. 3 is a flowchart of a step of generating a power distribution pricing model in a method for load scheduling of a commercial HVAC system according to an embodiment of the present invention.

Referring to FIG. 3, the processor 5000 may generate a thermal reaction model (S1000).

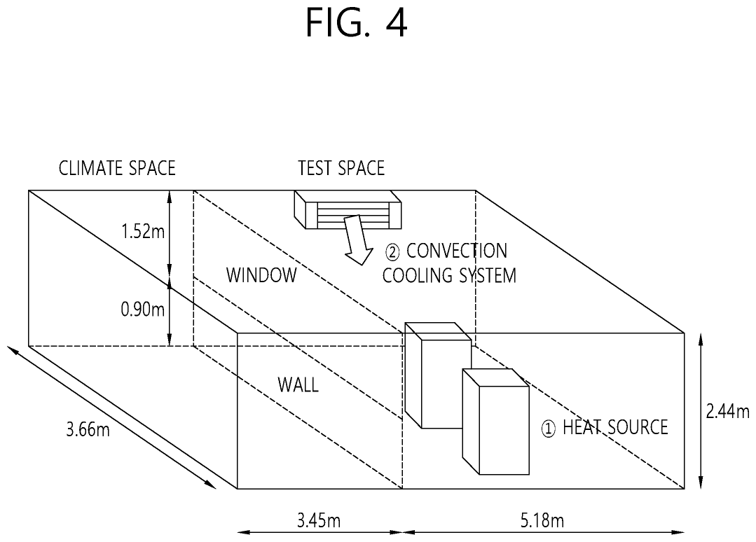

More specifically, the thermal reaction model may be a model for reflecting a heat loss rate of a target space that varies depending on a surrounding environment and a time condition when a low-level decision model is generated while a decision model to be described later is generated. The thermal reaction model will be described in more detail with reference to FIG. 4.

FIG. 4 is an image of a test experimental model for generating a thermal reaction model according to an experimental example of the present invention.

Referring to FIG. 4, the thermal reaction model may have modeled a room temperature change of a target space according to a surrounding environment and time, as described above.

Measurement of the Internal Heat Gain Over Time of the Test Space According to the Experimental Example of the Present Invention

The experimental space, which is 8.63 m×3.66 m×2.44 m, where the room temperature is kept constant, is divided into two sections by the walls containing the windows, and a test space area of 5.18 m×3.66 m×2.44 m and a climate space area of 3.45 m×3.66 m×2.44 m are prepared.

Thereafter, an illumination and a heat source and a variable speed heat pump (VSHP), which is one type of a HVAC system, are disposed in the test space area to measure the room temperature Tₕₜ of the test space area over 2000 hours.

In order to confirm the internal heat gain of the test space area according to the experimental example of the present invention, the experimental results are summarized by a model using an inverse transfer function (ITF).

The room temperatures of a building, in which a commercial HVAC system is installed, by spaces and time zones, can be generalized as shown in Equation (1) based on the result of the experiment.

$${T}_{ht} = {\sum }_{k = t - 3}^{t - 1} {a}_{hk} {T}_{hk} + {\sum }_{k = t - 3}^{t} ( {b}_{hk} {T}_{ak} + {c}_{hk} {T}_{xk} + {d}_{hk} {Q}_{hk} + {e}_{hk} {Q}_{ck} + {f}_{hk} {Q}_{rk} ) , ∇ h , ∇ t . \qquad [ Equation 1 ]$$

Tₕₜ: room temperature at time t

Tₐₜ: ambient temperature at time t

Tₓₜ: ambient temperature at time t

Qₕₜ: cooling rate of HVAC unit h at time t

Q_{ct}: indoor convection gain at time t

Qᵣₜ: radiant heat gain at time t

aₕₜ to fₕₜ: parameters

The variables of the ambient temperature Tₐₜ, the atmospheric temperature Tₓₜ, the indoor convection gain Q_{ct} and the radiation heat gain Qₓₜ in Equation 1 can be obtained from the operating information of the building in which the corresponding commercial HVAC system is installed.

At this time, the parameters aₕₜ to fₕₜ may vary depending on the structure of the building and the direction in which the building is located. Accordingly, the room temperature Tₕₜ measurement data of the object space calculated using the thermal reaction model according to Equation 1 is compared with the measurement data provided by the target building in which the commercial HVAC system is installed, to thereby be reflected in the power distribution pricing model to be described later.

In order to simplify the thermal reaction model according to Equation 1 above, the following Equation 2 can be expressed using the parameter gₕₜ representing the environmental condition of the target building. Herein, gₕₜ may be bₕₜTₐₜ+cₕₜTₓₜ+eₕₜQ_{ct}+fₕₜQᵣₜ.

$${T}_{ht} = {\sum }_{k = t - 3}^{t - 1} {a}_{hk} {T}_{hk} + {\sum }_{k = t - 3}^{t} ( {d}_{hk} {Q}_{hk} + {g}_{hk} ) , ∀ h , ∀ t , \qquad [ Equation 2 ]$$

gₕₜ: parameter

The room temperature Tₕₜ in the thermal reaction model according to Equation 2 can be converted into the relation of the cooling rate Qₕₜ for each time t provided by the commercial HVAC system h, as shown in the following Equation 3. At this time, δₘₕₖ may be a partial input power to be described with reference to FIG. 4.

$${Q}_{ht} = {{q}_{3 , ht} ( {\sum }_{m = 1}^{{N}_{I}} {δ}_{mht} )}^{3} + {{q}_{2 , ht} ( {{\sum }^{{N}_{I}}}_{m = 1} {δ}_{mht} )}^{2} + {q}_{1 , ht} {\sum }_{m = 1}^{{N}_{I}} {δ}_{mht} + {q}_{0 , ht} , \\ ∀ h , ∀ t . \qquad [ Equation 3 ]$$

Qₕₜ: Overall commercial HVAC system cooling rate

δₘₕₖ: partial input power

Also, the room temperature Tₕₜ for the total input power of the commercial HVAC system can be simplified as shown in the following Equation 4 using the above-described Equations 2 and 3.

$${T}_{ht} = {{\sum }_{k = 1}}^{t} {f}_{k} ( {δ}_{mhk} ) , ∀ h , ∀ t . \qquad [ Equation 4 ]$$

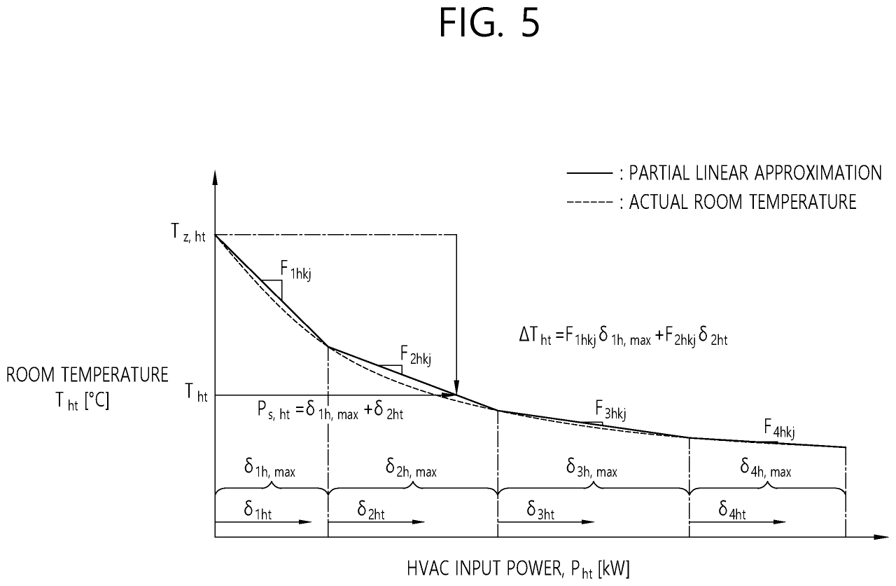

FIG. 5 is a graph of a room temperature change according to an increase in input power of a commercial HVAC system according to an embodiment of the present invention.

Referring to FIG. 5, the variation of the room temperature change Tₕₜ according to the input power increase over time of the commercial HVAC system simplified by Equation 4 can be expressed by a nonlinear curve graph A.

Further, based on the curve graph A, the indoor temperature change for the partial input power can be expressed as a straight line graph B of the partial linear approximation, based on the segment m of the input power.

More specifically, m may be the power segment, h may be the number of HVAC systems, and t may be the time at partial input power δₘₕₜ of a commercial HVAC apparatus.

Here, when the partial input power δₘₕₜ represents a value between 0 and δ_{mh, max}, the linear slope Fₘₕₜⱼ of the room temperature Tₕₜ at the partial input power δₘₕₜ can be expressed as a constant linear gradient B of the room temperature Tₕₜ at time t=j, which is determined by the m-th segment power of the commercial HVAC system h at time t=k (k≤j).

In other words, the operating range of the commercial HVAC system from 0 to P_{h, max} can be divided into N_{L} segments. Accordingly, the nonlinear thermal reaction in the building for the input power of the commercial HVAC system can be approximated as shown in Equation 5 by the partial linearization method.

$${T}_{ht} ≅ {T}_{z , ht} + {\sum }_{m = 1}^{{N}_{L}} {\sum }_{j = 1}^{t} {F}_{mhtj} {δ}_{mhj} , ∀ h , ∀ t . \qquad [ Equation 5 ]$$

N_{L}: Number of power segments

Fₘₕₜⱼ: Linear slope

In Equation 5, δₘₕₜ increases from 0 to δ_{mh,max} after δ₍ₘ₋₁₎ₕₜ increases to δ_{(m-1)h,max}. Otherwise, δₘₕₜ is fixed to zero. This can be achieved using the binary variable bₘₕₜ.

Referring to FIG. 4 again, the generalized Equation 1 is a formula obtained using a test model according to the experimental example of the present invention. Therefore, Equation 1 can be converted into Equation 6 which is applicable to a building having multiple zones by using the Inverse Transfer Function (ITF) (hereinafter, referred to as “ITF model”).

More specifically according to an embodiment, the ITF model applied to Equation 1 can interact with at least one ITF model of different zones. Therefore, an extended ITF model can be integrated with the HVAC system model. Thus, the extended ITF model is represented by a set of non-linear curves for the internal temperature for each zone, and the individual curves can be expressed similarly to the curve graph B of FIG. 4.

$${T}_{ht}^{e} ≅ {T}_{z , ht}^{e} + {\sum }_{m = 1}^{{N}_{L}} {\sum }_{j = 1}^{t} {F}_{mhtj}^{e} {δ}_{mhj} , ∀ h , ∀ t , ∀ e , \qquad [ Equation 6 ]$$

Accordingly, the thermal reaction model can be expressed by approximating the room temperature Tₕₜ^{e} of each zone by using partial linearization, as shown in Equation 6 above. Where Fₘₕₜⱼ^{e} may reflect the interaction between the plurality of zones for the operation of the commercial HVAC system.

Therefore, the load scheduling method of the commercial HVAC system according to the embodiment of the present invention can calculate the distribution fee based on the thermal reaction model reflecting the internal heat gain of the target space for each time zone, to thereby allow the minimized power distribution pricing and provide a load scheduling method with high accuracy and high performance while securing the thermal comfort of the commercial HVAC system users.

Referring again to FIG. 3, the processor 5000 may generate a decision model (S1300). Here, the decision model may include a high-level decision model and a low-level decision model.

In general, the goal of the power distribution company may be different from the goal of the user of the commercial HVAC system at the power distribution pricing. For example, the profit may be the top priority to the power distribution company while the maximum power efficiency and the lowest cost may be the top priority to the user of the commercial HVAC system.

Accordingly, the power distribution pricing model for load scheduling of the load scheduling apparatus according to the embodiment of the present invention reflect a model of a stepwise decision model between a power distribution company and a commercial HVAC system user based on the Stackelberg game theory.

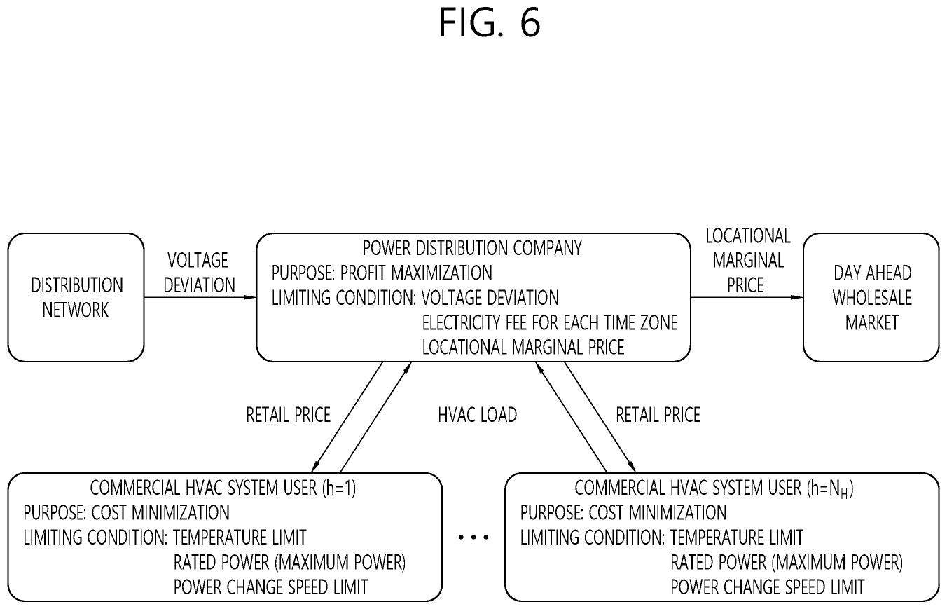

More specifically, the processor 5000 may calculate the maximum profit of the power distribution company using the high-level decision model (S1310). A method of calculating the maximum profit for a power distribution company using a high-level decision model will be described in more detail in FIG. 6.

FIG. 6 is a conceptual diagram for explaining a profit calculation of a commercial HVAC system according to an embodiment of the present invention.

Referring to FIG. 6, the profit of a power distribution company can be defined as the fee obtained from the user of the commercial HVAC system minus the purchase cost of the input power according to the locational marginal price (LMP) purchased in the wholesale market on the previous day, the incremental power loss of power in the distribution network, and the bus voltage deviation.

Equation 7 below summarizes a method of calculating the optimal distribution power price Cₜ maximizing the profit J_{DV} of the power distribution company according to the embodiment of the present invention.

$${arg max}_{{C}_{t}} {J}_{DV} = {\sum }_{t = 1}^{{N}_{T}} {C}_{t} {\sum }_{v ∈ {V}_{B}}^{{N}_{B}} {\sum }_{h = 1}^{{N}_{H}^{v}} {\sum }_{m = 1}^{{N}_{L}} {δ}_{mht}^{v} - {\sum }_{t = 1}^{{N}_{T}} {M}_{t} {\sum }_{v ∈ {V}_{B}}^{{N}_{B}} {\sum }_{h = 1}^{{N}_{H}^{v}} {\sum }_{m = 1}^{{N}_{L}} {δ}_{mht}^{v} - {\sum }_{t = 1}^{{N}_{T}} {M}_{t} {L}_{s , t} , \\ {M}_{t} \leq {C}_{t} \leq {U}_{t} , ∀ t , \qquad [ Equation 7 ]$$

Cₜ: distribution power price

J_{DV}: maximum profit

δₘₕₜ^{v}: partial input power

Mₜ: wholesale Price

Lₜ: incremental power loss

N_{T}: number of times to schedule time intervals per day

N_{B}: number of buses connected to HVAC systems

N^{V}_{H}: number of HVAC units in distribution network bus v

N_{L}: number of Line Blocks

Here, the lower list of the distribution power price Cₜ may be set as the wholesale price Mₜ, and the TOU (Time Of Use) amount Uₜ for each time zone may be set as the upper limit. At this time, since Ut is predetermined, the profit J_{DC}=Σₜ(Uₜ−Mₜ)·ΣᵥΣₕP^{v}_{c,ht}−MₜL_{c,t} of the power distribution company in the business-serving conventional HVAC units is not changed, and it may be added to Equation 7 in order to estimate the total profit J_{D}=J_{DV}+J_{DC}. In addition, Equation 7 includes the cost of incremental power loss caused by price sensitive HVAC units in the distribution network.

Accordingly, although the power distribution pricing model according to the embodiment of the present invention may cause a profit reduction of the power distribution company in the short term, as a result, by inducing the demand reaction of the users of the commercial HVAC system according to the reduction of the electric fee, the satisfaction level of both the power distribution company and the commercial HVAC system users can be enhanced.

In addition, the power distribution pricing model according to the embodiments of the present invention can prevent indiscreet profit seeking of power distribution companies and secure flexibility of the commercial HVAC system load, to thereby provide a power distribution pricing model with high efficiency and high stability.

The lower part of Equation 7 represents lower and upper boundaries of Cₜ. In particular, Cₜ may be set to be at least equal to or smaller than Uₜ. Here, Ut applies to both price sensitive HVAC systems and conventional HVAC systems. In particular, since Cₜ is higher than Mₜ, the profit of the power distribution company can be secured.

In order to calculate the incremental power loss of Equation 7, the processor 5000 can modify the sum Pₜ^{V} of the input power of the entire commercial HVAC system of a specific bus V at a specific time t within the distribution network as shown in Equation 8 below.

$${\sum }_{h = 1}^{{N}_{H}^{v}} {\sum }_{m = 1}^{{N}_{L}} {δ}_{mht}^{v} + {\sum }_{h = 1}^{{N}_{C}^{v}} {P}_{c , ht}^{v} = {P}_{s , t}^{v} + {P}_{c , t}^{v} = {P}_{t}^{v} , ∀ t , ∀ v , \qquad [ Equation 8 ]$$

V: bus

N_{H}^{V}: number of HVAC systems of RTP scheme

N_{L}^{V}: number of power segments

N_{C}^{V}: number of HVAC systems of TOU calculation scheme

The ratio of N_{H}^{V} to N_{C}^{V} in Equation 8 can be adjusted to analyze the change in Cₜ.

The processor 5000 then can express the sum of the input power Pₜ^{V} of the entire commercial HVAC system in the case that the bus V is included in V_{B} (V∈V_{B}={1, 13, 18, 42, 47, 52, 57, 60, 63, 67, 76, 81, 89, 97, 101}) in the form of Equation 9 below.

$${P}_{t}^{v} = {[ {P}_{t}^{1} , {P}_{t}^{13} , … {P}_{t}^{v} , … {P}_{t}^{101} ]}^{T} , ∀ t , ∀ v , \qquad [ Equation 9 ]$$

Processor 5000 can derive the sum of the input power Pₜ^{V} of the entire commercial HVAC system as Equation 10 and Equation 11 by using the power flow equation for the three phase network. Accordingly, the processor 5000 can convert the incremental power loss Lₜ and the deviation ΔVₜ of the bus voltage in the distribution network into the sensitivity matrices J_{loss,t} and J_{v,t}, respectively, to thereby be calculated.

J_{loss,t}·A·P_{s,t}^{v}=L_{s,t}∀t,∀v, [Equation 10]

L_{s,t}: incremental power loss

J_{loss,t}: sensitivity matrix of incremental power loss

A: a matrix that converts individual HVAC loads into a total HVAC load on a distribution network bus.

P^{V}_{S,T}: RTP-based HVAC system total input power sensitive to retail price at time t and bus v

$$[ \begin{matrix}{J}_{V , t} \\ - {J}_{V , t}\end{matrix} ] \cdot A \cdot {P}_{t}^{v} = [ \begin{matrix}Δ {V}_{t} \\ - Δ {V}_{t}\end{matrix} ] \leq [ \begin{matrix}Δ {V}_{max} \\ Δ {V}_{max}\end{matrix} ] , \\ for {t}_{p s} \leq t \leq {t}_{pc} , ∀ v , \\ where Δ {V}_{t} = {J}_{V , t} [ \begin{matrix}Δ {P}_{t} \\ Δ {Q}_{t}\end{matrix} ] = [ \begin{matrix}{J}_{V , t}^{P} & {J}_{V , t}^{Q}\end{matrix} ] [ \begin{matrix}Δ {P}_{t} \\ Δ {Q}_{t}\end{matrix} ] , \qquad [ Equation 11 ]$$

A·Pₜ^{v}: column vector

ΔVₜ: variation of bus voltage

J_{v,t}: sensitivity matrix of bus voltage deviation

tₚₛ: start time of peak time

tₚₑ: end time of peak time

Referring to Equation 11, in the processor 5000, ΔVₜⁿ value of all the buses (n∈N_{B}) in the distribution network, which is generated by the Pₜ^{v} in all the buses belonging to the N_{B} in the peak time zone (tₚₛ≤t≤tₚₑ), may be maintained as ±ΔVₘₐₓ.

At this time, the conversion matrix A for calculating the incremental power loss Lₜ and the deviation ΔVₜ of the bus voltage in the distribution network can be defined as the following Equation 12.

$$A = [ \begin{matrix}{a}^{11} & {a}^{12} & … & {a}^{1 v} & … \\ {a}^{21} & {a}^{22} & … & {a}^{2 v} & … \\ ⋮ & ⋮ & ⋱ & ⋮ & … \\ {a}^{n 1} & {a}^{n 2} & … & {a}^{nv} & … \\ ⋮ & ⋮ & ⋮ & ⋮ & ⋱\end{matrix} ] , \\ ∀ n , ∀ v , n ∈ {N}_{A} , v ∈ {N}_{B} , \\ {a}^{nv} = \{ \begin{matrix}{[ \begin{matrix}\frac{1}{3} & \frac{1}{3} & \frac{1}{3} & {O}_{1 \times 3}\end{matrix} ]}^{T} , & for n = v , \\ {O}_{6 \times 1} , & for n \neq v ,\end{matrix} \qquad [ Equation 12 ]$$

More specifically, each element of Pₜ^{v} in the above Equation 11 can be rearranged according to the network topology. According to the embodiment, each element of A·Pₜ^{v} may be expressed for bus n=V, and the entire commercial HVAC system load Pₜ^{V} may be expressed as 6·N_{A} elements as in Equation 13.

A·Pₜ^{v}=[[Pₜ^{1a}Pₜ^{1b}Pₜ^{1c}O₁ₓ₃],O₁ₓ₆ . . . [Pₜ^{13a}Pₜ^{13b}Pₜ^{13c}O₁ₓ₃]O₁ₓ₆ . . . [Pₜ^{va}Pₜ^{vb}Pₜ^{vc}O₁ₓ₃]O₁ₓ₆ . . . ]^{T},∀v,∀t,v∈N_{B} [Equation 13]

[Pₜ^{va}, Pₜ^{vb}, Pₜ^{vc}]^{T}: three-phase active power

[Qₜ^{va}, Qₜ^{vb}, Qₜ^{vc}]^{T}: three-phase reactive power

Herein, assuming that the commercial HVAC system load Pₜ^{V} is a 3 phase balanced condition, the 3 phase active power Pₜ^{V} may be set as Pₜ^{va}=Pₜ^{vb}=Pₜ^{vc}=⅓ ·Pₜ^{v}, and the 3 phase reactive power Qₜ^{va}, Qₜ^{vb}, Qₜ^{vc} may be set to 0. Therefore, according to the embodiment, when the commercial HVAC system is a variable speed drive (VSD), the variable speed drive (VSD) operates at a unit power factor, thereby improving the energy efficiency and efficiency of use of the converter capacity.

Referring again to FIG. 3, the processor 5000 may calculate the optimal operating cost of the commercial HVAC system according to the partial input power at a particular bus v in the distribution network using a low-level decision model (S1350).

More specifically, according to the embodiment, the optimal operating cost of the commercial HVAC system according to the partial input power δₘₕₜ^{v} can be expressed as Equation 14.

$${arg min}_{{δ}_{mht}^{v}} {J}_{UV}^{v} = {\sum }_{t = 1}^{{N}_{T}} {C}_{t} {\sum }_{h = 1}^{{N}_{H}^{v}} {\sum }_{m = 1}^{{N}_{L}} {δ}_{mht}^{v} , \qquad [ Equation 14 ]$$

δₘₕₜ^{v}: partial input power

At this time, the total operating cost (J_{UC}^{v}=ΣₜUt·ΣvΣh P^{v}_{c,ht}) of the commercial HVAC system in the specific bus v of the distribution network is constant and does not affect the optimal partial input power δₘₕₜ^{v} value and may be combined with Equation 14 to be expressed (J_{U}^{v}=J_{UV}^{v}+J_{UC}^{v}).

$$\begin{matrix}{T}_{ht , min}^{v} \leq {T}_{z , ht}^{v} + {\sum }_{m = 1}^{{N}_{L}} {\sum }_{j = 1}^{t} {F}_{mhtj}^{v} \cdot {δ}_{mhj}^{v} \leq {T}_{ht , max}^{v} , \\ ∀ h , ∀ t , & [ Equation 15 ] \\ {δ}_{mh , max}^{v} \cdot {b}_{mht}^{v} \leq {δ}_{mht}^{v} \leq {δ}_{mh , max}^{v} , for m = 1 , ∀ h , ∀ t , & [ Equation 16 ] \\ {δ}_{mh , max}^{v} \cdot {b}_{mht}^{v} \leq {δ}_{mht}^{v} \leq {δ}_{mh , max}^{v} \cdot {b}_{( m - 1 ) ht}^{v} , \\ for 2 \leq m \leq {N}_{L} - 1 , ∀ h , ∀ t , & [ Equation 17 ] \\ 0 \leq {δ}_{mht}^{v} \leq {δ}_{mh , max}^{v} \cdot {b}_{( m - 1 ) ht}^{v} , for m = {N}_{L} , ∀ h , ∀ t , & [ Equation 18 ] \\ 0 \leq {\sum }_{m = 1}^{{N}_{L}} {δ}_{mht}^{v} \leq {P}_{h , max}^{v} , ∀ h , ∀ t , & [ Equation 19 ]\end{matrix}$$

Σδₘₕₜ^{v}: input power of commercial HVAC systems

P_{h,max}^{v}: maximum input power of commercial HVAC systems

$${D}_{h}^{v} \leq ( {P}_{s , ht}^{v} - {P}_{s , h ( t - Δ {t}_{min} )}^{v} ) / Δ {t}_{unit} \leq {R}_{h}^{v} , ∀ h , ∀ t . \qquad [ Equation 20 ]$$

Dₕ^{v}: decrease speed limit of input power

Rₕ^{v}: increase rate limit of input power

Δtᵤₙᵢₜ: unit time interval (1 h)

The processor 5000 can apply the thermal reaction model in the above Equation 5 to the above Equation 15 so that the approximated room temperature Tₕₜ^{v} can be maintained between T_{ht,min}^{v} and T_{ht,max}^{v}.

More specifically, referring to FIG. 5, the processor 5000 may set the boundary conditions given to δₘₕₜ^{v} disclosed in Equation 16 using the binary variable bₘₕₜ^{v} in order to complete the partial linear approximation.

According to the boundary conditions according to the embodiment, δₘₕₜ may increase from 0 to δ_{mh,max} only after δmht δ₍ₘ₋₁₎ₕₜ is increased to δ_{(m-1)h,max}.

In addition, the boundary conditions may include a condition that the input power Σδₘₕₜ^{V} of the commercial HVAC systems should be smaller than the maximum input power P_{h,max}^{V} according to Equation 19 and a condition that an increase limit Rₕ^{V} of the input power and a reduction limit D_{H}^{v} of the input power during a unit time interval (Δtᵤₙᵢₜ=1 h).

According to the embodiment, when the commercial HVAC system is provided as a Variable Speed Heat Pump (VSHP), the increase limit Rₕ^{v} of the input power during the unit time interval (Δtᵤₙᵢₜ=1 h) can be determined within a range where no serious operating stress is applied to the compressor.

The lower level decision model among the load scheduling methods according to the embodiment of the present invention reflects the thermal reaction model described above to determine the operating cost of the commercial HVAC system according to the partial input power, to thereby provide a load scheduling method with high performance and high efficiency, in which the minimum power distribution pricing is possible while securing the thermal comfort of the commercial HVAC system user.

Thereafter, the processor 5000 may generate a power distribution pricing model using the generated decision model (S1500).

In other words, the processor 5000 may combine one high level decision model and a plurality of low level decision models to generate a pricing model. Accordingly, the load scheduling apparatus according to the embodiment of the present invention can set an operation schedule of at least one HVAC system existing in the distribution network.

More specifically, according to the embodiment, referring to Equation 16 and Equation 18, in the processor 5000, the binary variable bₘₕₜ^{v} for the partial linear approximation may be set as 0≤bₘₕₜ^{v}≤1 if bₘₕₜ^{v} ∈{0, 1}. At this time, the scheduling by δₘₕₜ^{v} can be maintained as it is.

Thereafter, the KKT condition can be applied to the lower decision model to generate the pricing model, to thereby derive a Lagrange equation and a complementary slack condition, as in Equation 21 below.

∇_{δ}_{ₘₕₜ}_{^{v}}L(Cₜ,δₘₕₜ^{v},μ_{ωht}^{v},β_{ρmht}^{v},η_{λmht}^{v},α_{ψht}^{v})=0,∀m,∀h,∀t,∀ω,∀ρ,∀λ,∀ψ,∀v, [Equation 21]

0≤y_{ω}^{v}(Tₕₜ^{v})⊥μ_{ωht}^{v}≥0,∀h,∀t,∀ω,∀v,

0≤h_{ρ}^{v}(δₘₕₜ^{v})⊥β_{ρmht}^{v}≥0,∀m,∀h,∀t,∀ρ,∀v,

0≤d_{λ}^{v}(δₘₕₜ^{v},bₘₕₜ^{v})⊥η_{λmht}^{v}≥0,∀m,∀h,∀t,∀λ,∀v,

0≤g_{ψ}^{v}(P_{s,ht}^{v})⊥α_{ψht}^{v}≥0,∀m,∀h,∀t,∀ψ,∀v. [Equation 22]

In order to apply the KKT condition, the binary variable bmhtv bₘₕₜ^{v}∈{0, 1} for partial linear approximation in Equation 16 to Equation 18 can be relaxed to 0≤bₘₕₜ≤1. At this time, referring to FIG. 5, when the time t is k and j, the absolute value of Fₘₕₖⱼ, which is the slope of the partially linearized curve, may monotonically decrease as the load of the commercial HVAC system increases, so that the schedule of the partial input power δₘₕₜ^{v} may be maintained constant.

The processor 5000 may then apply the KKT condition together with the relaxed bᵣᵤₙₜ condition to the lower level decision model, to thereby generate a power distribution pricing model for the optimal partial input power Σₘδₘₕₜ^{v} according to the retail price Cₜ between the power distribution company and the user of the commercial HVAC system as shown in Equation 23 below.

$${arg max}_{{C}_{t} , {δ}_{mht}^{v}} {J}_{DV} = {\sum }_{t = 1}^{{N}_{T}} {C}_{t} {\sum }_{v = 1}^{{N}_{B}} {\sum }_{h = 1}^{{N}_{H}^{v}} {\sum }_{m = 1}^{{N}_{L}} {δ}_{mht}^{v} - {\sum }_{t = 1}^{{N}_{T}} {M}_{t} {\sum }_{v = 1}^{{N}_{B}} {\sum }_{h = 1}^{{N}_{H}^{v}} {\sum }_{m = 1}^{{N}_{L}} {δ}_{mht}^{v} - {\sum }_{t = 1}^{{N}_{T}} {M}_{t} {L}_{t} - π \cdot ϑ , \qquad [ Equation 23 ]$$

η: upper limit of sum of complementary slackness term

π: positive constant

Herein, when Equation 22 is satisfied, ϑ may become 0 for constant π.

In this regard, the following constraints may exist.

μ_{ωht}^{v}≥0,α_{ψht}^{v}≥0,β_{ρmht}^{v}≥0,η_{λmht}^{v}≥0,∀m,∀h,∀t,∀ω,∀ψ,∀ρ,∀λ,∀v, [Equation 24]

Referring again to FIG. 2, the processor 5000 may perform load scheduling for the next day of the commercial HVAC system based on the power distribution pricing model (S5000).

More specifically, since the power distribution pricing model of the RTP charge method has a large difference in the charge rates between the peak time zone and the off-peak time zone, the operation of the load in the HVAC system to be used next day can be scheduled in advance.

The power distribution pricing method of the commercial HVAC system and the apparatus and method for load scheduling of the HVAC system utilizing the same according to the embodiment of the present invention have been described above.

The power distribution pricing method of the commercial HVAC system and the apparatus and method for load scheduling of the HVAC system utilizing the same according to the embodiment of the present invention can provide scheduling of the load according to the price of the input power which set on the previous day, to thereby provide a power distribution pricing method of the commercial HVAC system with high accuracy, high efficiency and high reliability, and an apparatus and method for load scheduling of the HVAC system using the method. Also, it is possible to guarantee the thermal comfort of the users of the commercial HVAC system, and at the same time, by providing optimal power efficiency information according to the retail price of the input power, it is possible to provide a power distribution pricing method of a high-efficiency commercial HVAC system and an apparatus and method for load scheduling of the HVAC system using the same.

The operation of the method according to an embodiment of the present invention can be implemented as a computer-readable program or code on a computer-readable recording medium. The computer-readable recording medium includes all kinds of recording devices in which data that can be read by a computer system is stored. The computer-readable recording medium may also be distributed in a networked computer system so that a computer-readable program or code can be stored and executed in a distributed manner.

In addition, the computer-readable recording medium may include a hardware device configured to store and execute program instructions, such as a ROM, a RAM, a flash memory, and the like. Program instructions may include machine language codes such as those produced by a compiler, as well as high-level language codes that may be executed by a computer using an interpreter or the like.

While some aspects of the present invention have been described in the context of an apparatus, it may also represent a description according to a corresponding method. Herein, the block or apparatus corresponds to a method step or the feature of the method step. Similarly, aspects described in the context of a method may also be represented by features of the corresponding block or item or corresponding device. Some or all of the method steps may be performed by (or by using), for example, a microprocessor, a programmable computer, or a hardware device such as an electronic circuit. In some embodiments, one or more of the most important method steps may be performed by such an apparatus.

In embodiments, a programmable logic device (e.g., a field programmable gate array) may be used to perform some or all of the functions of the methods described herein. In embodiments, the field programmable gate array may operate in conjunction with a microprocessor to perform one of the methods described herein. Generally, the methods are preferably performed by some hardware device.

Although the present invention was described with reference desired embodiments, it will be apparent to those skilled in the art that various modifications and variations can be made in the present invention without departing from the spirit or scope of the invention as defined in the following claims.

What is claimed is:

1. An apparatus for scheduling a load, the apparatus comprising:
a memory; and
a processor configured to execute at least one command within the memory,
wherein the processor schedules a load of a commercial HVAC (heating, ventilation, air conditioning) system, based on a power distribution pricing model associated with operating efficiency of the HVAC system according to a retail price of input power.

2. The apparatus of claim 1, wherein the power distribution pricing model is derived by using a decision model.

3. The apparatus of claim 2, wherein the decision model includes an upper level decision model for calculating the retail price of the input power which guarantees a profit of a power distribution company.

4. The apparatus of claim 3, wherein the upper level decision model calculates the profit of the power distribution company by deducting a wholesale price of the input power and an incremental power loss in a power distribution network from the retail price of the input power in a specific bus in the power distribution network which supplies the input power.

5. The apparatus of claim 4, wherein the retail price of the input power is an amount of money between the wholesale price of the input power and a retail price of the input power which is calculated by a time-of-use (TOU) scheme for each time zone.

6. The apparatus of claim 2, wherein the decision model includes a lower level decision model for calculating an optimal operating cost for partial input power for each user of the at least one commercial HVAC system in a specific bus within a power distribution network which supplies the input power.

7. The apparatus of claim 6, wherein the lower level decision model reflects a partial linear approximated section of the input power corresponding to a specific room temperature in a thermal reaction model, to thereby calculate an operating cost according to the input power within the approximated section.

8. The apparatus of claim 7, wherein the thermal reaction model is modeled by measuring a change in a room temperature according to a surrounding environment and time change in a specific space.

9. The apparatus of claim 8, wherein the surrounding environment includes at least one of variables including a surrounding temperature, an air temperature, an indoor convection current heat gain, an indoor radiant heat gain, and a cooling rate of the commercial HVAC system.

10. The apparatus of claim 1, wherein the scheduling is performed is performed for a load within the HVAC system to be used a next day.

11. The apparatus of claim 1, wherein the power distribution pricing model is based on a real-time pricing scheme.

12. A method for scheduling a load, the method comprising:
calculating a retail price according to input power, based on a power distribution pricing model; and
scheduling at least one load within a commercial HVAC (heating, ventilation, air conditioning) system to be used a next day, according to the calculated retail price.

13. The method of claim 12, further comprising:
generating the power distribution pricing model before calculating the retail price according to the input power based on the power distribution pricing model.

14. The method of claim 13, wherein the generating of the power distribution pricing model comprises:
calculating the retail price of the input power which guarantees a profit of a power distribution company by using an upper level decision model; and
calculating an optimal operating cost for partial input power for each user of the at least one commercial HVAC system in a specific bus within a power distribution network which supplies the input power by using a lower level decision model.

15. The method of claim 14, wherein the upper level decision model calculates the profit of the power distribution company by deducting a wholesale price of the input power and an incremental power loss in a power distribution network from the retail price of the input power in a specific bus in the power distribution network which supplies the input power.

16. The method of claim 15, wherein the retail price of the input power is an amount of money between the wholesale price of the input power and a retail price of the input power which is calculated by a time-of-use (TOU) scheme for each time zone.

17. The method of claim 12, wherein the generating of the power distribution pricing model by using the decision model comprises:
generating a thermal reaction model before calculating the retail price of the input power which guarantees the profit of the power distribution company by using the upper level decision model.

18. The method of claim 17, wherein the thermal reaction model is modeled by measuring a change in a room temperature according to a surrounding environment and time change in a specific space.

19. The method of claim 12, wherein the power distribution pricing model is based on a real-time pricing scheme.

20. A power distribution pricing method for an input power distributed to a commercial HVAC (heating, ventilation, air conditioning) system, the power distribution pricing method comprising:
calculating a retail price of the input power in a specific bus within a power distribution network;
calculating a partial input power use amount for the retail price of at least one user of the commercial HVAC system; and
calculating the retail price of the input power by reflecting the partial input power use amount.
